(19) United States
(12) Patent Application Publication
(10) Pub. No.: US 2005/0259757 A1
(43) Pub. Date: Nov. 24, 2005

(54) Frequency domain equalization in communications systems with scrambling

(75) Inventors: Shiquan Wu, Toronto (CA); Jean-Philippe Laroche, Toronto (CA); Rene J. C. Lamontagne, Toronto (CA); Frank R. Kschischang, Toronto (CA); Jeffrey T. Daines, Toronto (CA)

Correspondence Address: KATTEN MUCHIN ROSENMAN LLP, 525 WEST MONROE STREET, CHICAGO, IL, 60661-3693, US

(73) Assignee: SOMA Networks, Inc., San Francisco, CA (US)

(21) Appl. No.: 10/521,582

(22) PCT Filed: Jul. 16, 2003
(86) PCT No.: PCT/CA03/01018

§ 371 Date: Jan. 18, 2005

Related U.S. Application Data
(60) Provisional application No. 60/396,096, filed on Jul. 17, 2002.
(60) Provisional application No. 60/433,772, filed on Dec. 17, 2002.

(51) Int. Cl. H04K 1/10

(52) U.S. Cl. 375/260

(57) ABSTRACT

A method of, and system for applying frequency-domain equalization in a DS-CDMA system, either by augmenting the transmitted data block before it is scrambled by appending a prefix and a suffix known to or knowable by the receiver or by augmenting the transmitted data block after it is scrambled but prior to transmission so that it has a scrambled cyclic prefix. In the former case, the receiver synthesizes one of the prefix, the data block, or the suffix that would have been received if the augmented transmitted data block after scrambling had had a cyclic prefix.

### FIELD OF THE INVENTION

The present invention relates to a method of, and system for, providing frequency domain equalization in a Direct-Sequence Code-Division Multiple-Access (“DS-CDMA”) system.

### BACKGROUND OF THE INVENTION

Communication channels suffer from dispersion (time-spreading) of the transmitted signal. In radio channels, for example, dispersion is caused by the fact that the received signal is actually a superposition of various echoes and reflections of the transmitted signal, each of which has taken a different physical propagation path. In other channel media, such as wireline systems, the different propagation speeds of different frequencies and other phenomena can result in similar dispersion. These different signal components can interfere constructively or destructively, resulting in signal-level fluctuations called multi-path fading.

Whatever the mechanism for dispersion, a commonly employed model for this effect is the linear discrete-time tapped delay-line model shown in FIG. 1. In this model, the received signal y[n] is related to the transmitted signal x[n] by the equation

$$y [ n ] = {\sum }_{i = 0}^{L} {h}_{1} x [ n - i ] + w [ n ] ,$$

where L is the “response length” or “delay spread” of the channel and w[n] represents noise. The channel response length L and the tap coefficients h₀, h₁, . . . h_{L} may be fixed (as, for example, in wired channels) or random (as, for example, in radio channels). For the purposes of this discussion, it will be assumed that the receiver has knowledge of the channel, i.e., the receiver somehow knows a priori or is able to estimate L and h₀, h₁, . . . , h_{L}. Mechanisms by which the receiver might achieve this knowledge are outside the scope of this invention, but are well known. For example, this knowledge could be achieved by transmission and analysis, at the receiver, of an appropriate reference sequence, known both to the transmitter and the receiver. For simplicity in this discussion it is also assumed that channel noise can be ignored by setting w[n]=0 for all n.

It will be noted that a transmitted symbol x[0] not only propagates through the channel itself, but it also interferes with x[1], x[2], . . . , x[L] because of channel delay or “memory”. This interference between symbols is known as inter-symbol interference (“ISI”). Generally speaking, a channel equalizer is any kind of processor implemented at a receiver that attempts to “undo” or counter the ISI induced by the channel. A linear equalizer is typically some sort of (usually adaptive) filter implemented at the receiver (refer to FIG. 1), prior to the decision device that makes decisions about which symbols were sent. An effective equalizer assists the decision device in making reliable decisions by reducing or, ideally, eliminating the influence of the ISI.

Equalization can be quite a complex operation, representing a considerable portion of receiver's computational load. Methods to reduce this computational load are, therefore, of great interest. Frequency Domain Equalization (“FDEq”) is one such method that involves the computation of two Fast Fourier Transforms (“FFTs”) and a number of complex multiplications. Under most circumstances the computational load contributed by an FDEq can be much less than that of a time domain equalizer.

Generally, FDEq becomes viable only when the number of computations needed to implement the two FFTs and the complex multiplications is smaller than the multiply-accumulates (over the same block) needed to implement a conventional time-domain equalizer. Assuming a channel response length L and a data block size M, a conventional time domain equalizer requires on the order of M times L (O(ML)) multiply-accumulate operations. In contrast, a frequency-domain equalizer requires O(M log₂ M+M)=O(M log₂ M) operations, independent of L. When L is much larger than log₂ M, the computational complexity of the FDEq can be considerably less that of the conventional time domain equalizer, resulting in impressive computational savings.

In FIG. 2, the processes involved in a conventional system using time-domain equalization of a signal containing a payload data block 10 (which is referred to as the “the payload 10”) from a transmitter through a channel to a receiver are shown. The transmitter, the channel, and the receiver are generally indicated by reference numerals 12, 14, and 16, respectively. In all of the drawings, data blocks such as the payload 10 are represented as rectangles and processes acting upon the signals containing data blocks are represented as hollow arrows. For example, the processing taking place in the channel 14 is indicated by a hollow arrow 18 directed from the transmitter 12 toward the receiver 16.

For the purposes of analysis in following discussion, the channel process 18 is assumed to be accurately modeled by the discrete-time tapped delay-line model described by the equation above in which the channel response length L and tap coefficients h₀, h₁, . . . , h_{L} are known. The payload 10 may be represented as a length-M sequence of symbols x[0], x[1], . . . , x[M−1]. M is assumed to be much larger than the channel response length L, although for convenience the drawings suggest that L is a substantial fraction of M. The symbols x[0], x[1], . . . , x[M−1] of the payload 10 may be assumed to be drawn from some alphabet of complex-valued scalars.

Equalization can be made tractable by ensuring that in passing through the channel 14 the payload 10 is not influenced by previous transmissions. One method for doing so is shown in FIG. 2. A length-L guard interval of zero symbols is appended to the payload 10 as a prefix 20 to form an augmented block 22. The zero symbols clear the channel memory ahead of the payload 10, so that no ISI from previous transmissions affects the payload 10 as it passes through the channel 14. The prefix 20 may be represented as the sequence of symbols x[−L], x[−L+1], . . . , x[−1]. The operation of appending the prefix 20 to the payload 10 is indicated by a hollow arrow 24 in the transmitter 12. The augmented block 22 passes through the channel 14 in which it is processed by the channel process 18 and is received by the receiver 16 as a received prefix 26 corresponding to the transmitted prefix 20 followed by a received payload 28 corresponding to the transmitted payload 10. Then, according to the equation above, the received payload 28 may be represented as the sequence of symbols y[0], y[1], . . . , y[M−1], where:

$$y [ 0 ] = {h}_{0} x [ 0 ] , \\ y [ 1 ] = {h}_{0} x [ 1 ] + {h}_{1} x [ 0 ] , \\ y [ 2 ] = {h}_{0} x [ 2 ] + {h}_{1} x [ 1 ] + {h}_{2} x [ 0 ] , \\ ⋮ ⋮ \\ y [ M - 1 ] = {h}_{0} x [ M - 1 ] + {h}_{1} x [ M - 2 ] + … + {h}_{L} x [ M - L - 1 ] .$$

The received payload 28 therefore depends only upon the symbols of the transmitted payload 10 and the tap coefficients of the channel 14. The received prefix 26 is discarded as it may be affected by ISI from previously transmitted symbols. The received payload 28 is equalized by a time-domain equalization process 30 and an estimated payload 32 determined.

In FIG. 3, the processes involved in a conventional system using frequency-domain equalization are shown. Rather than a guard interval of zero symbols, a prefix 34 that is a copy of the last L symbols 36 of the payload 10 is appended to the payload 10. The prefix 34 may be represented as the sequence of symbols x[−L], x[−L+], . . . , x[−1]. The values of the last L symbols 36 of transmitted payload 10 may be represented as the sequence of symbols x[M−L], x[M−L+1], . . . , x[M−1]. Then the values of the symbols of the prefix 34 are given by:
x[−L]=x[M−L], x[−L+1]=x[M−L+1], . . . , x[−1]=x[M−1].
The operation of appending the prefix 34 to the payload 10 is indicated by a hollow arrow 40 in FIG. 3 directed from the last L symbols 36 of the payload 10 to the prefix 34.

The prefix 34 in FIG. 3 is also a form of guard interval, except that the transmitted signal during it is not necessarily zero. The prefix 34 and the payload 10 together form an augmented block 38, which may be represented as the sequence of symbols x[−L], x[−L+1], . . . , x[M−1]. It is important to note that this particular (data-dependent) choice of the prefix 34 makes the augmented block 38 appear to be periodic with period M, at least over the time interval of the augmented block 38. For this reason, this particular choice of the prefix 34 is often referred to as a periodic extension of the payload 10.

As the augmented block 38 passes through the channel 14, a corresponding received block 42, which may be represented as the sequence of symbols y[−L], y[−L+1], . . . , y[M−1], is received by the receiver 16. The received block 42 consists of a payload 44 corresponding to the transmitted payload 10 that is given by:

$$y [ 0 ] = {h}_{0} x [ 0 ] + {h}_{1} x [ M - 1 ] + {h}_{2} x [ M - 2 ] + … + {h}_{L} x [ M - L ]$$

$$y [ 1 ] = {h}_{0} x [ 1 ] + {h}_{1} x [ 0 ] + {h}_{2} x [ M - 1 ] + … + {h}_{L} x [ M - L + 1 ]$$

$$⋮ ⋮$$

$$y [ M - 1 ] = {h}_{0} x [ M - 1 ] + {h}_{1} x [ M - 2 ] + … + {h}_{L} x [ M - L - 1 ]$$

and a prefix 46 that corresponds to the transmitted prefix 34 of the augmented block 38. The received prefix 46 is discarded because, as was the case for the time-domain equalizer discussed above, it contains ISI from previously transmitted symbols. The remaining system of equations is conveniently expressed the following matrix form:

$$[ \begin{matrix}y [ 0 ] \\ y [ 1 ] \\ y [ 2 ] \\ ⋮ \\ y [ M - 1 ]\end{matrix} ] = \\ [ \begin{matrix}{h}_{0} & 0 & 0 & ⋯ & {h}_{L} & {h}_{L - 1} & {h}_{L - 2} & ⋯ & {h}_{3} & {h}_{2} & {h}_{1} \\ {h}_{1} & {h}_{0} & 0 & ⋯ & 0 & {h}_{L} & {h}_{L - 1} & ⋯ & {h}_{4} & {h}_{3} & {h}_{2} \\ {h}_{2} & {h}_{1} & {h}_{0} & ⋯ & 0 & 0 & {h}_{L} & ⋯ & {h}_{5} & {h}_{4} & {h}_{3} \\ ⋮ & ⋮ & ⋮ & ⋰ & ⋮ & ⋮ & ⋮ & ⋰ & ⋮ & ⋮ & ⋮ \\ 0 & 0 & 0 & ⋯ & {h}_{L - 1} & {h}_{L - 2} & {h}_{L - 3} & ⋯ & {h}_{2} & {h}_{1} & {h}_{0}\end{matrix} ] [ \begin{matrix}x [ 0 ] \\ x [ 1 ] \\ x [ 2 ] \\ ⋮ \\ x [ M - 1 ]\end{matrix} ]$$

As is well known to those skilled in the art, an M×M circulant matrix is characterized by the property that, for i>1, the ith row of the matrix is a cyclic shift of the previous, i.e., (i−1) th, row. Writing y for the column vector (y[0], y[1], . . . , y[M−1])^{T} and x for the column vector (x[0], x[1], . . . , x[M−1])^{T}, it will be apparent that
y=circ(h₀,0, . . . , 0, h_{L}, h_{L-t}, . . . , h₁)x
where circ(v) denotes the circulant matrix whose first row is the vector v. In other words, the received payload 44 is equal to a circulant matrix times the transmitted payload 10. By performing the periodic extension the natural linear convolution of the channel response has been converted into an apparent circular convolution.

In addition to describing the process shown in FIG. 3 as a periodic extension, it is also commonly referred to as adding an “identical cyclic prefix”.

It is further well known to those skilled in the art that a circulant matrix has the property that it is diagonalized by the Discrete Fourier Transform (“DFT”). The DFT can be computed in a computationally efficient manner by FFT algorithms. In this case, since the channel response is represented by a circulant matrix, the DFT diagonalizes the channel independently of the particular channel response. A principal reason that it is useful to have a diagonal matrix representing the channel response is that such a matrix describes a channel with M sub-channels having no cross-talk or coupling between sub-channels. Each sub-channel is uncorrelated with the others. In other words, in the frequency domain, the channel 14 behaves as a collection of independent sub-channels and each sub-channel can be equalized independently of the others in a manner understood by those skilled in the art (involving a complex multiply for each sub-channel). The equalized received data block is then put back into the time domain by determining the IDFT.

Hence in the processing shown in FIG. 3, the DFT of the received payload 44 is determined, followed by a complex multiply per frequency bin, and then followed by the computation of the inverse DFT to obtain an estimate 50, which may be represented as the sequence of symbols x′[0], x′[1], . . . , x′[M−1], of the transmitted payload 10. In FIG. 3, the DFT, complex multiplies, and the IDFT are collectively indicated by hollow arrow 48.

The overall computational complexity of the process shown in FIG. 3 is O(M log₂ M+M)=O(M log₂ M) operations, which is independent of the channel response length L. As illustrated in FIG. 4 of Falconer, S. L. Ariyavisitakul, A. Benyamin-Seeyar and B. Eidson, “Frequency Domain Equalization for Single-Carrier Broadband Wireless Systems,” IEEE Commun. Magazine, vol. 40, pp. 58-66, April 2002, which is hereby incorporated by reference, the computational savings, relative to a conventional time-domain equalizer, can be quite substantial.

The procedure described above in relation to FIG. 3 is applied in conventional orthogonal frequency-division multiplexing (“OFDM”) and single carrier broadband systems. However, to date this procedure has not worked in DS-CDMA communication systems. In DS-CDMA systems each user is assigned a different set of “signature” or “spreading” sequences with which to transmit information. For example, one user might be assigned the sequence set
{(+1,−1,+1,−1),(−,+1,−1,+1)}.
   This user would transmit a bit with a value of zero by, say, sending the first sequence in his set, and a bit with a value of one by sending the second sequence in the set. A DS-CDMA system, in this form, is quite compatible with the cyclic-prefix frequency domain equalization method described above, since a periodically extended data sequence will automatically map into a periodically extended spread sequence.

A major problem arises, however, when the DS-CDMA system uses a scrambling code. A scrambling code is a periodic sequence (usually over the alphabet {−1,+1}) with an enormously long period that is used to pseudo-randomly scramble the transmitted data sequence. Each transmitted data block is multiplied symbol-by-symbol by some portion of the spreading code. The intended receiver is assumed to be synchronized with the scrambling code, so that it can “undo” the scrambling. Different scrambling codes are typically assigned to different sectors and/or different cells in a cellular environment, so as to randomize the inter-sector and inter-cell interference that arises. To date, it has not been possible to use FDEq as described above in DS-CDMA communication systems of this type.

### SUMMARY OF THE INVENTION

It is an object of the present invention to provide a novel method and system for equalization of signals in a DS-CDMA communication system.

In accordance with a first aspect of the present invention there is provided a method of equalizing a received scrambled block that was transmitted through a channel, the scrambled block having a prefix, a payload, and a suffix that was not identical to the prefix when the scrambled block was transmitted. The method comprises the steps of: determining a synthesized prefix of a synthesized block that would have been received if the suffix of the scrambled block had been identical to the prefix when the scrambled block was transmitted; forming the synthesized block from the synthesized prefix and the received scrambled block by replacing the prefix of the received scrambled block with the synthesized prefix; determining a discrete Fourier transform of the synthesized block to obtain a determined discrete Fourier transform; performing a frequency domain equalization on the determined discrete Fourier transform; and determining an inverse discrete Fourier transform of the result of the frequency domain equalization to obtain an estimate of the scrambled payload that was transmitted.

In accordance with a second aspect of the present invention there is provided a method of equalizing a received scrambled block that was transmitted through a channel, the scrambled block having a prefix, a payload, and a suffix that was not identical to the prefix when the scrambled block was transmitted. The method comprises the steps of: determining a synthesized payload of a synthesized block that would have been received if the suffix of the scrambled block had been identical to the prefix when the scrambled block was transmitted; forming the synthesized block from the synthesized payload and the received scrambled block by replacing the payload of the received scrambled block with the synthesized payload and removing the prefix of the received scrambled block; determining a discrete Fourier transform of the synthesized block to obtain a determined discrete Fourier transform; performing a frequency domain equalization on the determined discrete Fourier transform; and determining an inverse discrete Fourier transform of the result of the frequency domain equalization to obtain an estimate of the scrambled payload that was transmitted.

In accordance with a third aspect of the present invention there is provided a method of equalizing a received scrambled block that was transmitted through a channel, the scrambled block having a prefix, a payload, and a suffix that was not identical to the prefix when the scrambled block was transmitted. The method comprises the steps of: determining a synthesized suffix of a synthetic block that would have been received if the suffix of the scrambled block had been identical to the prefix when the scrambled block was transmitted; forming the synthesized block from the synthesized suffix and the received scrambled block by replacing the suffix of the received scrambled block with the synthesized suffix and removing the prefix of the received scrambled block; determining a discrete Fourier transform of the synthesized block to obtain a determined discrete Fourier transform; performing a frequency domain equalization on the determined discrete Fourier transform; and determining an inverse discrete Fourier transform of the result of the frequency domain equalization to obtain an estimate of the scrambled payload that was transmitted.

In accordance with a fourth aspect of the present invention there is provided a method of transmitting a payload through a channel to a receiver. The method comprises the steps of: scrambling the payload; forming a scrambled block in which the scrambled payload is preceded in the scrambled block by a prefix that is identical to a suffix portion of the scrambled payload; transmitting the scrambled block through the channel to the receiver; at the receiver, determining a discrete Fourier transform of a received payload that corresponds to the scrambled payload; performing a frequency domain equalization on the determined discrete Fourier transform; determining an inverse discrete Fourier transform of the result of the frequency domain equalization to obtain the scrambled payload; and the scrambled payload to recover an estimate of the transmitted payload.

In accordance with a fifth aspect of the present invention there is provided a method of transmitting a payload through a channel to a receiver. The method comprises the steps of: scrambling the payload; forming a scrambled block in which the scrambled payload is followed in the scrambled block by a suffix that is identical to a prefix portion of the scrambled payload; transmitting the scrambled block through the channel to the receiver; at the receiver, determining a discrete Fourier transform of a received block that corresponds to the portion of the transmitted scrambled block following the prefix portion of the scrambled payload; performing a frequency domain equalization on the determined discrete Fourier transform; determining an inverse discrete Fourier transform of the result of the frequency domain equalization to obtain the scrambled payload; and unscrambling the scrambled payload to recover an estimate of the transmitted payload.

### BRIEF DESCRIPTION OF THE DRAWINGS

Preferred embodiments of the present invention will now be described, by way of example only, with reference to the attached drawings, in which:

FIG. 1 is a schematic representation of a prior art tapped delay-line channel model;

FIG. 2 is a schematic representation of the operation of a prior art equalizer using a guard interval of zeros;

FIG. 3 is schematic representation of the operation of a prior art equalizer using a cyclic prefix or periodic extension;

FIG. 4 is schematic representation of the operation of an equalizer in accordance with an embodiment of the invention in which a received prefix is replaced by a synthesized prefix;

FIG. 5 is schematic representation of the operation of another equalizer in accordance with an embodiment of the invention in which a received payload is replaced by a synthesized payload;

FIG. 6 is schematic representation of the operation of another equalizer in accordance with an embodiment of the invention in which a received suffix is replaced by a synthesized suffix;

FIG. 7 is schematic representation of overlapping blocks to reduce overhead;

FIG. 8 is schematic representation of the operation of another equalizer in accordance with an embodiment of the invention in which a scrambled suffix is copied and the copy appended to a transmitted scrambled payload as a scrambled prefix;

FIG. 9 is schematic representation of the operation of another equalizer in accordance with an embodiment of the invention in which a scrambled prefix is copied and the copy appended to a transmitted scrambled payload as a scrambled suffix;

FIGS. 10A and 10B are schematic representations of a receiver and a transmitter that are embodiments of the invention; and

FIGS. 11A, 11B, and 11C are schematic representations of a transmitter and two receivers that are embodiments of the invention.

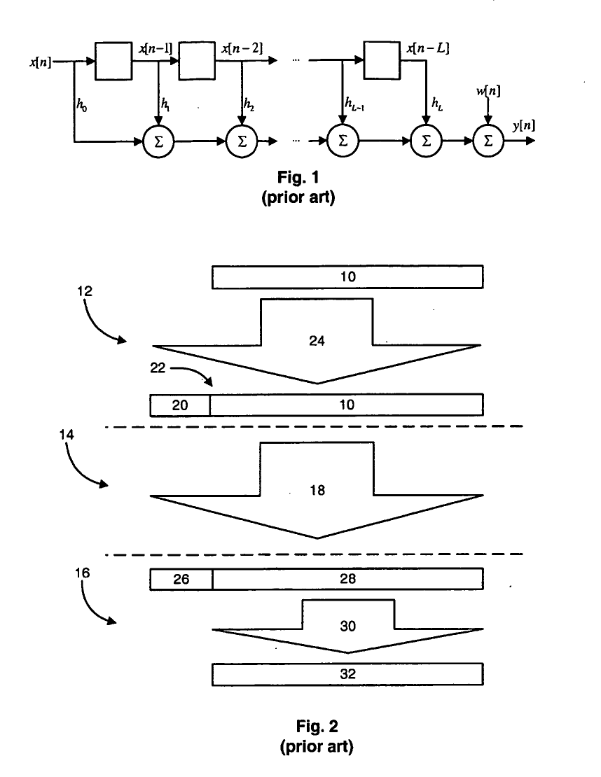

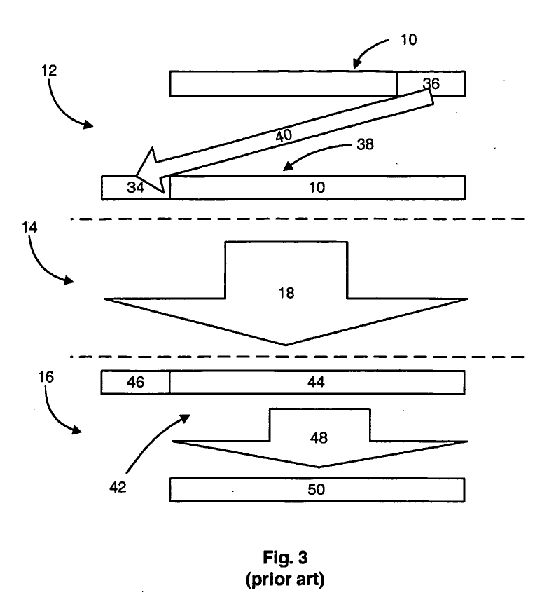

### DETAILED DESCRIPTION OF THE INVENTION

As discussed above, to date frequency-domain equalization has not been possible in DS-CDMA systems. In accordance with embodiments of the present invention, to apply frequency-domain equalization to such a DS-CDMA system, either the transmitted data block is augmented before it is scrambled by appending a prefix and a suffix known to the receiver or the transmitted data block is augmented after it is scrambled but prior to transmission so that it has a scrambled cyclic prefix. In the former case, the receiver synthesizes the prefix, the data block, or the suffix that would have been received if the augmented transmitted data block after scrambling had had a cyclic prefix. In each variant embodiment of the invention the diagonalization process described above is applied to a received block or a synthesized block. To simplify the following discussion, it is assumed that the receiver “knows” (has previously determined) the channel response.

In the following description and in FIGS. 4-8, the data block to be transmitted is represented as the N-length sequence of symbols (x[0], . . . , x[N−1]). As above, the channel response length or channel memory Land the estimated tap coefficients h₀, h₁, . . . , h_{L} are assumed to be known to the receiver. Before the data block is transmitted, it is augmented in one of several ways as well as scrambled. In some embodiments of the present invention the data block is scrambled first and then augmented and in other variants the data block is augmented and then scrambled. The scrambling process in all cases is as follows: For each possible value of i, transmitted symbol x[i] is multiplied by scrambling sequence element s[i] to obtain the scrambled sequence z[i] where z[i]=s[i]x[i].

In the embodiment of the invention illustrated in FIG. 4, rather than transmitting a scrambled block that has a cyclic prefix, a received prefix is synthesized so that frequency-domain equalization can be applied to a synthesized received data block that appears to have had a cyclic prefix when it was transmitted. This comes at the cost of augmenting the input data block with a prefix and a suffix that are both known to the receiver, but transmitting known data may be necessary in any case to determine the channel memory L and an estimate of the tap coefficients h₀, h₁, . . . , h_{L}. Further, there is no repetition of the scrambling code sequence and no unusual synchronization required.

In FIG. 4, at a transmitter generally indicated by reference numeral 110, an input data block 112, which may be represented by the N-length sequence of symbols (x[0], . . . , x[N−1]), is augmented, to form an augmented block 114 by appending to it a prefix 116 and a suffix 118. The augmentation process is indicated by a hollow arrow 123 in FIG. 4. The prefix 116 may be represented by a sequence of symbols (x[−L], . . . , x[−1]) and the suffix 118 may be represented by a sequence of symbols (x[N], . . . , x[N+L−1]). The augmented block 114 is then scrambled by a scrambling process indicated by a hollow arrow 120, resulting in a scrambled block 122. The scrambled block 122 has a scrambled prefix 124 corresponding to the input prefix 116, which may be represented by a sequence of symbols (z[−L], . . . , z[−1]), a scrambled payload 126 corresponding to the input data block 112, which may be represented by a sequence of symbols (z[0], . . . , z[N−1]), and a scrambled suffix 128 corresponding to the input suffix 118, which may be represented by a sequence of symbols (z[N], . . . , z[N+L−1]).

The scrambled block 122 is then transmitted through a channel 130 to a receiver 132. The processing by the channel 130 of the scrambled block 122 is indicated in FIG. 4 by a hollow arrow 134. The receiver 132 receives a channel-processed block 136 that corresponds to the scrambled block 122 that was transmitted. The received block 136 has a received prefix 138, which corresponds to the scrambled prefix 124 and which may be represented by a sequence of symbols (y[−L], . . . , y[−1]), a received payload 140, which corresponds to the scrambled payload 126 and may be represented by a sequence of symbols (y[0], . . . , y[N−1]) and a received suffix 142, which corresponds to the scrambled suffix 128 and may be represented by a sequence of symbols (y[N], . . . , y[N+L−1]).

A synthesized prefix 144, which may be represented by ŷ[−L], . . . , ŷ[−1], is given by:

$$\hat{ y} [ - L ] = {h}_{0} z [ - L ] + {h}_{1} z [ N + L - 1 ] + \\ {h}_{2} z [ N + L - 2 ] + … + {h}_{L} z [ N ]$$

$$\hat{y} [ - L + 1 ] = {h}_{0} z [ - L + 1 ] + {h}_{1} z [ - L ] + \\ {h}_{2} z [ N + L - 1 ] + … + {h}_{L} z [ N + 1 ]$$

$$⋮ ⋮$$

$$\hat{y} [ - 1 ] = {h}_{0} z [ - 1 ] + {h}_{1} z [ - 2 ] + {h}_{2} z [ - 3 ] + … + {h}_{L} z [ N + L - 1 ] ,$$

and determined by a prefix synthesizing process that is represented in FIG. 4 by a hollow arrow indicated by reference numeral 146. That prefix synthesizing process 146 requires that the receiver have or be able to determine the estimated tap coefficients h₀, h₁, . . . , h_{L}, the scrambled prefix 124 (the sequence of symbols z[−L], . . . , z[−1]), and the scrambled suffix 128 (the sequence of symbols z[N], . . . , z[N+L−1]). In FIG. 4, hollow arrows directed from the blocks labeled 124 and 128 in the transmitter 110 to that prefix synthesizing process 146 in the receiver 132 indicate this use of known transmitted symbols by the receiver 132.

A synthesized block 148, which may be represented by ŷ[−L], . . . , ŷ[−1], y[0], . . . , y[N+L−1], is formed from the received block 136 by replacing the received prefix 138 with the synthesized prefix 144. The synthesized block 148 is then an estimate of what would have been received had the scrambled block 122 been preceded by a cyclic prefix when it was transmitted. It will be noted that the cyclic prefix referred to here would have preceded the scrambled prefix 124, not substituted for it.

The synthesized block 148 is then equalized in the frequency domain to produce an estimate 150 of the scrambled block 122, including an estimate 152 of the scrambled prefix 124, followed by an estimate 154 of the scrambled payload 126, and an estimate 156 of the scrambled suffix 128. The equalization process is indicated in FIG. 4 by a hollow arrow 158, The estimate 154 of the scrambled payload 126, which may be represented by a sequence of symbols (z′[0], . . . , z′[N−1]), is then unscrambled to obtain an estimate 159 of the input data block 112. That estimate 159 may be represented by a sequence of symbols (x′[0], . . . , x′[N−1]). In FIG. 4, the unscrambling process is indicated by a hollow arrow 160.

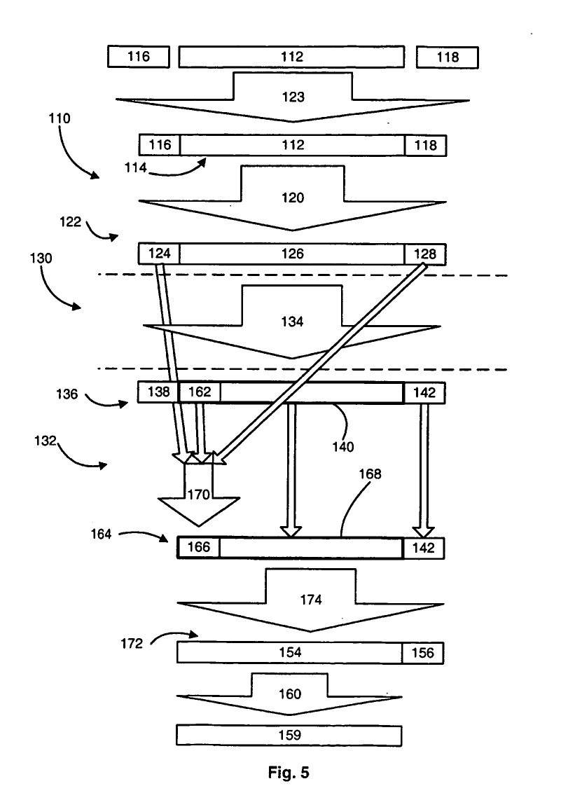

In the embodiment of the invention illustrated in FIG. 5, a payload portion of a received block is synthesized so that frequency-domain equalization can be applied to a synthesized received block that appears to have had a cyclic prefix when it was transmitted. As in the case of the embodiment illustrated in FIG. 4, this comes at the cost of augmenting the input data block with a prefix and a suffix known to the receiver.

The embodiment of the invention illustrated in FIG. 5 is identical to the embodiment of the invention illustrated in FIG. 4 up to the point at which the receiver 132 begins to process the received block 136. Continuing from there, the first L symbols of the received payload 140 are indicated in FIG. 5 by reference numeral 162 and are referred to as a contaminated portion 162. The contaminated portion 162 is shown in FIG. 5 as separated from the balance of the received payload 140 by a light line. A heavy line bounds the received payload 140.

Rather than forming a synthesized received block from the received block 136 by replacing the received prefix 138, in FIG. 5 a synthesized block 164 is formed from the received block 136 by discarding the received prefix 138 and replacing the contaminated portion 162 with a synthesized portion 166 to form a synthesized payload 168. In FIG. 5, a light line divides the synthesized portion 166 from the balance of the synthesized payload 168. The synthesized payload 168 is bounded by a heavy line. The received suffix 142 remains unchanged in the synthesized block 164. Other than the synthesized portion 166, the symbols of the synthesized payload 168 are the same as the corresponding symbols of the received payload 140. The synthesized portion 166, which may be represented by the sequence of symbols ŷ[0], . . . , ŷ[L−1], is given by:

$$\hat{ y} [ 0 ] = y [ 0 ] + {h}_{1} ( z [ N + L - 1 ] - z [ - 1 ] ) + \\ {h}_{2} ( z [ N + L - 2 ] - z [ - 2 ] ) + … + {h}_{L} ( z [ N ] - z [ - L ] )$$

$$\hat{ y} [ 1 ] = y [ 1 ] + {h}_{2} ( z [ N + L - 1 ] - z [ - 1 ] ) + {h}_{3} ( z [ N + L - 2 ] - \\ z [ - 2 ] ) + … + {h}_{L} ( z [ N + 1 ] - z [ - L + 1 ] )$$

$$⋮ ⋮$$

$$\hat{y} [ L - 1 ] = y [ L - 1 ] + {h}_{L} ( z [ N + L - 1 ] - z [ - 1 ] ) .$$

The determination of the synthesized portion 166 requires that the receiver have or be able to determine the estimated tap coefficients h₀, h₁, . . . , h_{L}, the contaminated portion 162 (the sequence of symbols y[0], . . . , y[L−1]), the scrambled prefix 124 (the sequence of symbols z[−L], . . . , z[−1]), and the scrambled suffix 126 (the sequence of symbols z[N], . . . , z[N+L−1]). This is indicated in FIG. 5 by hollow arrows directed from the blocks labeled 162, 122, and 126 to a hollow arrow labeled 170, which represents the process of determining the synthesized portion 166.

The synthesized block 164 is then equalized in the frequency domain to produce a scrambled estimate 172, which includes an estimate 154 of the scrambled payload 126 and an estimate 156 of the scrambled suffix 128. The equalization process is indicated in FIG. 5 by a hollow arrow 174. The estimate payload 154, which may be represented by a sequence of symbols (z′[0], . . , z′[N−1]), is then unscrambled to obtain an estimate 159 of the input data block 112. That estimate 159 may be represented by a sequence of symbols (x′[0], . . . , x′[N−1]). In FIG. 5, the unscrambling process is indicated by a hollow arrow 160.

It will be noted that equalization 174 is applied to L fewer symbols as compared to the embodiment shown in FIG. 4.

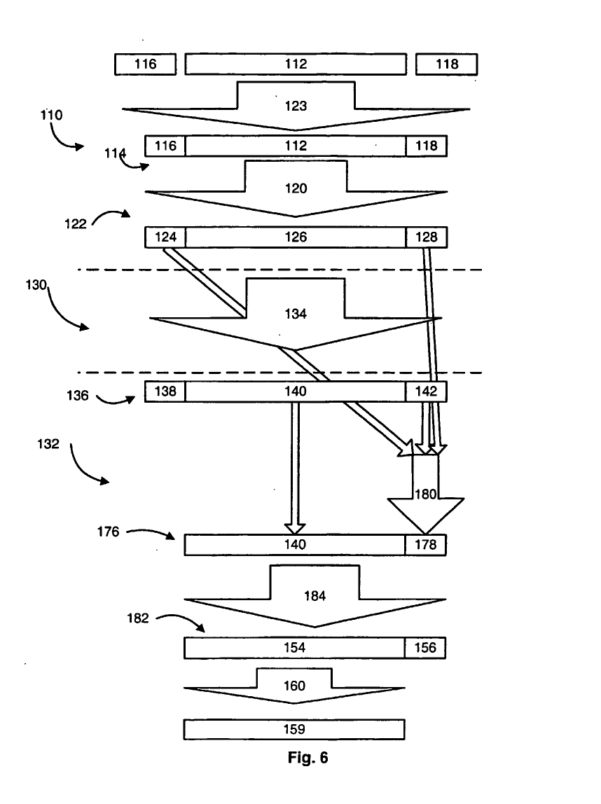

In the embodiment of the invention illustrated in FIG. 6, a suffix portion of a received block is synthesized so that frequency-domain equalization can be applied to a synthesized received block that appears to have had a cyclic prefix when it was transmitted. As in the case of the embodiment illustrated in FIG. 4, this comes at the cost of augmenting the input data block with a prefix and a suffix both known to the receiver.

The embodiment of the invention illustrated in FIG. 6 is identical to the embodiment of the invention illustrated in FIG. 4 up to the point at which the receiver 132 begins to process the received block 136. Continuing from there, a synthesized block 176 is formed from the received block 136 by discarding the received prefix 138 and replacing the received suffix 142 with a synthesized suffix 178. The received payload 140 remains unchanged in the synthesized block 176. The synthesized suffix 178, which may be represented by the sequence of symbols ŷ[N], . . . , ŷ[N+L−1], is given by:

$$\hat{ y} [ N ] = y [ N ] + {h}_{0} ( z [ - L ] - z [ N ] )$$

$$\hat{ y} [ N + 1 ] = y [ N + 1 ] + {h}_{0} ( z [ - L + 1 ] - \\ z [ N + 1 ] ) + {h}_{1} ( z [ - L ] - z [ N ] )$$

$$⋮ ⋮$$

$$\hat{y} [ N + L - 1 ] = y [ N + L - 1 ] + {h}_{0} ( z [ - 1 ] - z [ N + L - 1 ] ) + {h}_{1} ( z [ - 2 ] - z [ N + L - 2 ] ) + … + {h}_{L - 1} ( z [ - L ] - z [ N ] )$$

The determination of the synthesized suffix 178 requires that the receiver have or be able to determine the estimated tap coefficients h₀, h₁, h_{L}, the received suffix 142 (the sequence of symbols y[N], . . . , y[N+L−1]), the scrambled prefix 124 (the sequence of symbols z[−L], . . . , z[−1]), the scrambled suffix 128 (the sequence of symbols z[N], . . . , z[N+L−1]). This is indicated in FIG. 6 by hollow arrows directed from the blocks labeled 142, 124, and 128 to a hollow arrow labeled 180, which represents the process of determining the synthesized suffix 178.

The synthesized block 176 is then equalized in the frequency domain to produce a scrambled estimate 182, which includes an estimate 154 of the scrambled payload 128 and an estimate 156 of the scrambled suffix 128. The equalization process is indicated in FIG. 6 by a hollow arrow 184. The estimated payload 154, which may be represented by a sequence of symbols (z′[0], . . . , z′[N−1]), is then unscrambled to obtain an estimate 159 of the input data block 112. That estimate 159 may be represented by a sequence of symbols (x′[0], . . . , x′[N−1]). In FIG. 6, the unscrambling process is indicated by a hollow arrow 160.

In each of the embodiments of the invention described above, if the scrambled block 122 is preceded through the channel 130 by a similar block, then the suffix of the preceding block may be used as the scrambled prefix 124, reducing the overhead caused by transmitting known prefixes and suffixes rather than payload data. In effect, the blocks overlap. For example, a sequence of overlapping blocks is indicated by reference numeral 186 in FIG. 7. The first block 188, second block 190 and last block 192 of the sequence 186 are shown. The intervening blocks are indicated by an ellipsis. The first block consists of a prefix 194, a payload 196, and a suffix 198. The second block 190 has the suffix 198 of the first block as its prefix, a payload 200, and a suffix 202. This pattern of overlapping block continues until the sequence 186 ends with the last block 192, which consists of a prefix 204, a payload 206, and a suffix 208. In FIG. 7, the overlapping prefixes/suffixes 198, 202, 204 are indicated by blocks filled in with the letters “PS”, the prefix 194 is indicated by the letter “P” and the suffix 208 is indicated by the letter “S”. The payloads 196, 200, 206 are indicated by the letters “PL”.

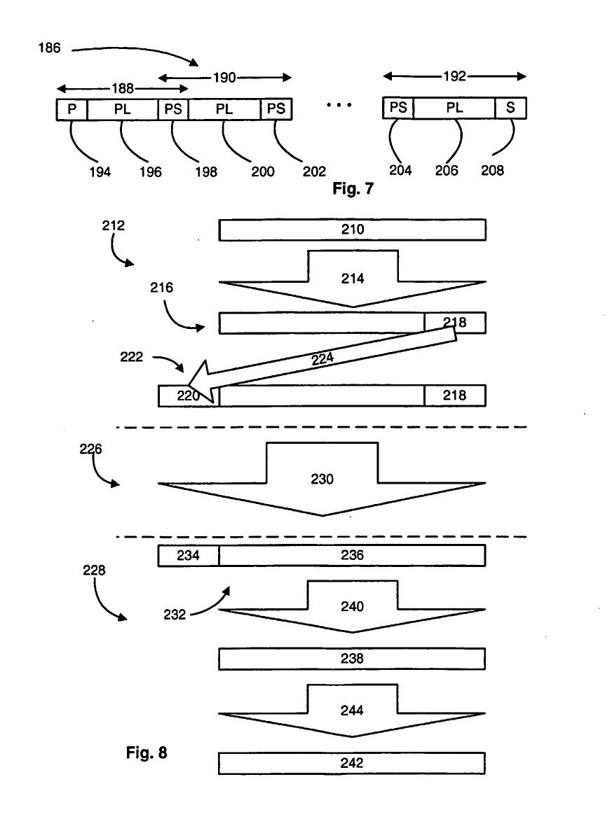

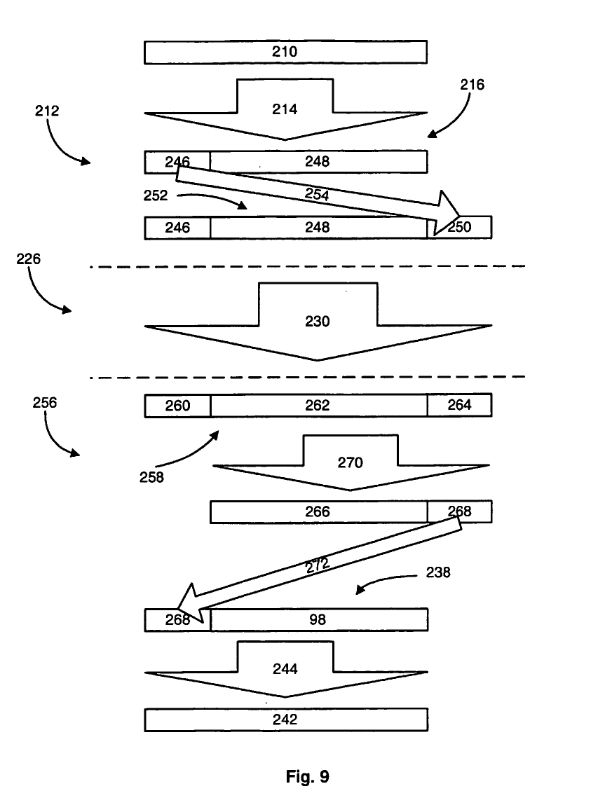

As illustrated in FIGS. 8 and 9, in two further embodiments of the present invention, an input data block to be transmitted is first scrambled and then augmented before transmission so that it has the desired cyclic prefix property. The known frequency-domain equalization process described above can then be applied to the received block. However, the estimated data block resulting from the frequency-domain equalization is scrambled and must be unscrambled before it can be outputted as an estimate of the transmitted data block.

More specifically, in FIGS. 8 and 9, an input data block 210, which may be represented by the N-length sequence of symbols (x[0], . . . , x[N−1]), is scrambled in a receiver 212 by a scrambling process indicated by a hollow arrow 214. The result is a scrambled input data block 216, which may be represented by the N-length sequence of symbols (z[0], . . . , z[N−1]).

In the embodiment of the invention illustrated in FIG. 8, the last L symbols of the scrambled input data block 216 form a scrambled suffix 218, which may be represented by a sequence of symbols (z[N−L], . . . , z[N−1]). The scrambled suffix 218 is copied and the copy appended to the front of the scrambled input data block 216 as a scrambled prefix 220 to form an augmented block 222. The process of copying the scrambled suffix 218 and appending it to the front of the scrambled input data block 216 is indicated in FIG. 8 by a hollow arrow 224. Since the sequence of symbols in the scrambled prefix 220 is identical to the sequence of symbols of the scrambled suffix 218, the augmented block 222 has the desired cyclic prefix property.

The augmented block 222 is then transmitted through a channel 226 to a receiver 228. The processing by the channel 226 of the augmented block 222 is indicated in FIG. 8 by a hollow arrow 230. The receiver 228 receives a channel-processed block 232 corresponding to the augmented block 222 that was transmitted. The received block 232 has a received prefix 234, which corresponds to the scrambled prefix 220 and may be represented by a sequence of symbols (y[−L], . . . , y[−1]) and a received data block 236, which corresponds to the scrambled input data block 216 and may be represented by a sequence of symbols (y[0], . . . , y[N−1]).

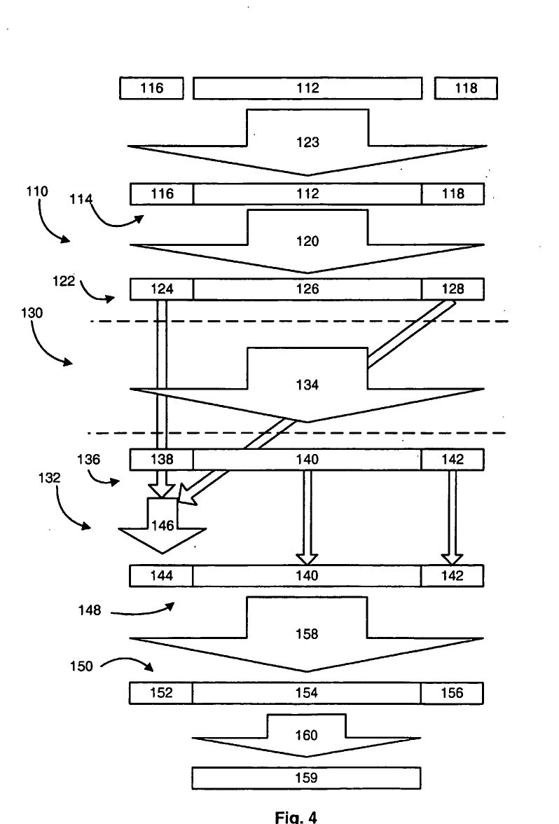

The received block 232 is then equalized in the same manner as described above in relation to FIG. 3. That is, the received prefix 234 is discarded and the received data block 236 is equalized in the frequency domain to produce a scrambled estimate 238 of the scrambled input data block 216. The equalization process is indicated by a hollow arrow 240. The scrambled estimate 238, which may be represented by a sequence of symbols (z′[0], . . . , z′[N−1]), is then unscrambled to obtain an estimate 242 of the input data block 210. That estimate 242 may be represented by a sequence of symbols (x′[0], . . . , x′[N−1]). In FIG. 8, the unscrambling process is indicated by a hollow arrow 244.

In the embodiment of the invention illustrated in FIG. 9, a scrambled input data block 216 is formed in the same manner as in the embodiment of the invention illustrated in FIG. 8. However, in this embodiment the scrambled input data block 216 is divided into a scrambled prefix 246, which may be represented by a sequence of symbols (z[0], . . . , z[L−1]), and a scrambled payload 248, which may be represented by a sequence of symbols (z[L], . . . , z[N−1]). The scrambled prefix 246 is copied and the copy appended to the end of the scrambled input data block 216 as a scrambled suffix 250 to form an augmented block 252. The process of copying the scrambled prefix 246 and appending it to the end of the scrambled input data block 216 is indicated in FIG. 9 by a hollow arrow 254. Since the sequence of symbols in the scrambled suffix 250 is identical to the sequence of symbols of the scrambled prefix 246, the augmented block 252 has the desired cyclic prefix property.

The augmented block 252 is then transmitted through the channel 226 to a receiver 256. The processing by the channel 226 of the augmented block 252 is indicated in FIG. 8 by a hollow arrow 230. The receiver 256 receives a channel-processed block 258 corresponding to the augmented block 252 that was transmitted. The received block 258 has a received prefix 260, which corresponds to the scrambled prefix 246 and which may be represented by a sequence of symbols (y[−L], . . . , y[−1]), a received payload 262, which corresponds to the scrambled payload 248 and which may be represented by a sequence of symbols (y[0], . . . , y[N−L−1]), and a received suffix 264, which corresponds to the scrambled suffix 250 and may be represented by a sequence of symbols (y[N−L], . . . , y[N−1]).

The received block 258 is then equalized in the same manner as described above in relation to FIG. 3. That is, the received prefix 260 is discarded because it has been contaminated by ISI from the preceding block. The remaining portion of the received block 258 is then equalized in the frequency domain to produce an estimate 266 of the scrambled payload 248 followed an estimate 268 of the scrambled suffix 250, which is also an estimate of the scrambled prefix 246. The equalization process is indicated in FIG. 8 by a hollow arrow 270. The estimated payload 266 and estimated suffix 268, which may be represented by a sequence of symbols (z′[L], . . . , z′[N−1]) and (z′[0], . . . , z′[L−1]), respectively, are then reordered in proper time sequence by a reordering operation indicated by hollow arrow 272 to form an estimate 238 of the scrambled input data block 216. The reordering operation 272 copies the estimated suffix 268 and appends it as a prefix to the estimated payload 266. The result is then unscrambled to obtain an estimate 242 of the input data block 210. That estimate 242 may be represented by a sequence of symbols (x′[0], . . . , x′[N−1]). In FIG. 8, the unscrambling process is indicated by a hollow arrow 244.

In FIGS. 8 and 9, the same reference numeral may be used for a process if the indicated process is the same in both drawings. Similarly, if a sequence of data symbols is the same in each drawing or an estimate of the same sequence, then the same reference numeral may be used.

The embodiments described in relation to FIGS. 8 and 9 have a drawback in that the augmented block 222, 252 that is transmitted in each case begins and ends with the same repeated sequence of symbols. In effect, the signal seen by nearby cells does not appear to be as random as would otherwise by the case because the scrambled prefix 220, 246 of an augmented block 222, 252 is identical to the scrambled suffix 218, 250 of that block. Also, the generation of scrambling and unscrambling sequences must be properly synchronized to account for the discarding of the received prefix 234, 260 of the received block 232, 258. For example, the scrambling and unscrambling sequence generators might be run discontinuously or, if run continuously, subsequences of the generated scrambling and unscrambling elements might be discarded periodically.

The embodiment of the invention described in relation to FIG. 8, while requiring a reordering process 272 may have an advantage in that the transmitter 212 may begin transmitting the augmented block 252 before the scrambled suffix 250 is appended to the scrambled payload 248.

In both the embodiment of the invention described in relation to FIG. 8 and the embodiment of the invention described in relation to FIG. 9, the input data block 210 may be partially known to the receiver 256; these embodiments of the invention operate in the same manner regardless of whether input data block 210 is entirely unknown or partially known to the receiver 256. The input data block 210 may be partially known by the receiver 256 in order to estimate the channel 226.

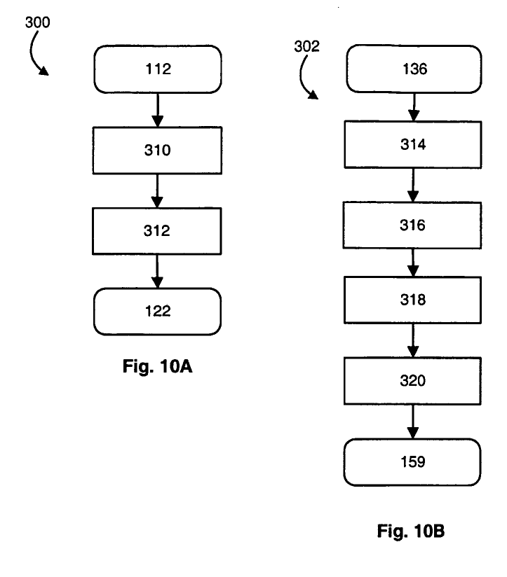

A transmitter 300 and a receiver 302 that may be used to implement the embodiments of the invention described in relation to FIGS. 4, 5, and 6 are shown in FIGS. 10A and 10B, respectively. Together, this transmitter 300 and receiver 302 comprise a system for transmitting scrambled CDMA encoded data in which frequency domain equalization is employed.

In the transmitter 300 of FIG. 10A, an input data block 112 is augmented by a block augmenter 310 before being before being scrambled by a scrambler 312 and the result outputted into the channel 130 as a scrambled block 122. The input data block 112 is augmented in the block augmenter 310 by adding a prefix 116 and a suffix 118.

In the receiver 302 of FIG. 10B, a block 136 is received from the channel 130, a synthesized data block 148, 164, 176 formed from the received block 136 by a synthesizer 314, the synthesized block 148, 164, 176 processed by a frequency domain equalizer 316, the result 150, 172, 176 unscrambled by an unscrambler 318, and a estimate 159 of the input data block 112 made by a decision device 320 and outputted. The inventive methods described above in relation to FIGS. 4, 5, and 6 could be employed in the receiver of FIG. 10B. The operation of the synthesizer 314 differs depending upon which method is employed.

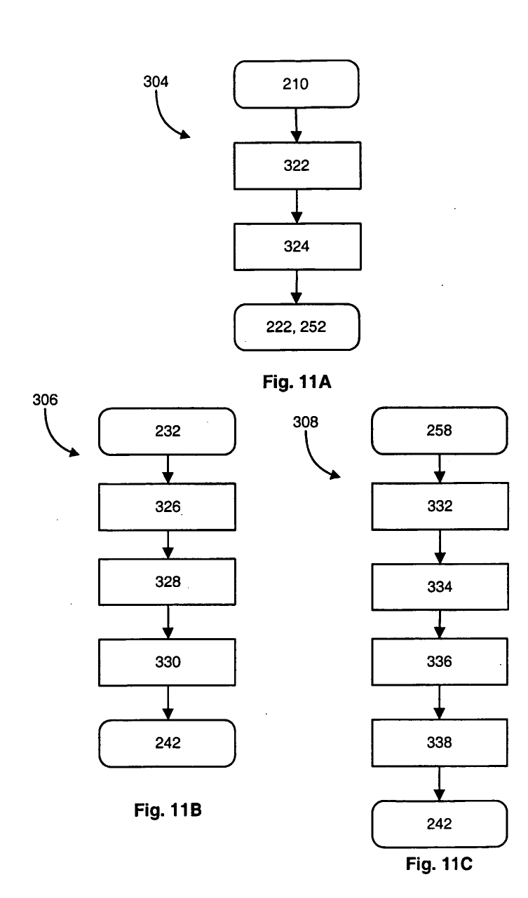

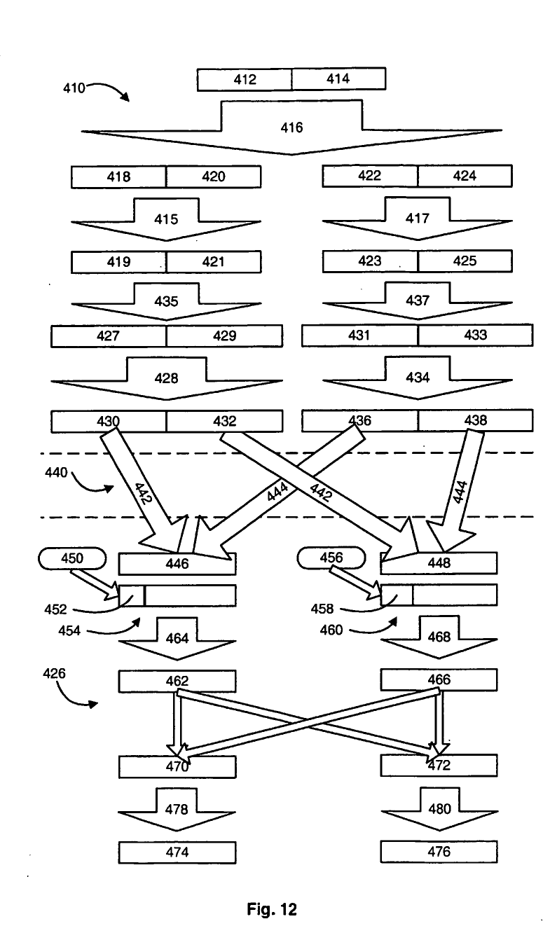

A transmitter 304 and two alternative receivers 306, 308 that may be used to implement the embodiments of the invention described in relation to FIGS. 8 and 9 are shown in FIGS. 11A, 11B, and 11C, respectively. Together, this transmitter 304 and receivers 306, 308 comprise a system for transmitting scrambled CDMA encoded data in which frequency domain equalization is employed.

In the transmitter 304 of FIG. 11A, an input data block 210 is scrambled by a scrambler 322 and the result augmented by a block augmenter 324 before being outputted into the channel 226 as an augmented block 222, 252. If the transmitter 304 were employed in the embodiment of the invention shown in FIG. 8, then the input data block 210 would first be scrambled in the scrambler 322 to produce a scrambled data block 216. Then a scrambled suffix 218 of the scrambled data block 216 would be copied and appended by the block augmenter 324 to the scrambled data block 216 as a prefix 220 to form the augmented data block 222. If the transmitter 304 is employed in the embodiment of the invention shown in FIG. 9, then a scrambled prefix 246 of the scrambled data block 216 would be copied and appended by the block augmenter 324 to the scrambled data block 216 as a suffix 250 to form an augmented data block 252.

In the receiver 306 of FIG. 11B the inventive method described above in relation to FIG. 8 is employed. A block 232 is received from the channel 226, equalized by a frequency domain equalizer 326, the equalized result unscrambled by an unscrambler 328, and an estimate 242 of the input data block 210 made by a decision device 330 and outputted.

In the receiver 308 of FIG. 11C the inventive method described above in relation to FIG. 9 is employed. A block 258 is received from the channel 226, a payload and a suffix 262/264 equalized by a frequency domain equalizer 332, the result 266/268 reordered by a block reformer 334, unscrambled by an unscrambler 334, and an estimate 242 of the input data block 210 made by a decision device 338 and outputted.

The invention may be embodied in communications systems that employ Space Time Transmit Diversity (“STTD”) coding. In its most simple form, STTD encoding operates upon successive pairs of symbols. Two antennas are used. One antenna (typically referred to as the “main antenna”) transmits the pair of symbols unchanged. The other antenna (typically referred to as the “diversity antenna”), which is spatially separated from the main antenna, transmits a discrete pair of data symbols that are rearrangements of the two symbols.

In a simple STTD system the main antenna transmits the two symbols in time sequence. The diversity antenna transmits the negative complex conjugate of the second symbol, followed in time by the complex conjugate of the first symbol. In contrast, the STTD system illustrated in FIG. 12 uses blocks that are many symbols long and that have known prefixes and suffixes as in the embodiments of the invention described above. By doing so, synthetic received blocks may be formed that correspond to the blocks that would have been received if the transmitted blocks had been preceded by cyclic prefixes. That in turn allows for simplified equalization in the frequency domain.

More specifically, at a transmitter, two successive input data blocks 412 and 414 are STTD encoded by an STTD encoding process indicated by a hollow arrow 416, resulting in two pairs of blocks. The transmitter is generally indicated by reference numeral 410 as the portion of FIG. 12 that is above the upper dashed horizontal line in FIG. 12. The first pair, indicated in FIG. 12 by reference numerals 418 and 420, are identical to the input data blocks 412 and 414, respectively. The second pair, which is indicated by reference numerals 422 and 424, are rearrangements of the symbols of the two input data blocks 412/414 made in the manner described in detail below.

The STTD encoding process 416 forms the first data block 422 of the second pair of STTD encoded data blocks by reversing the time order of the negative complex conjugate of the second input data block 414 and the second data block 424 of the second pair of STTD encoded data blocks by reversing the time order of the complex conjugate of the first input data block 412, in each case on a symbol-by-symbol basis.

Both pairs of STTD encoded data blocks 418/420 and 422/424 are then spread to obtain spread data blocks 419/421 and 423/425, respectively. The spreading processes are indicated in FIG. 12 hollow arrows 415 and 417, respectively.

Prefixes and suffixes known to the receiver, which is generally indicated by reference numeral 426 as the portion of FIG. 12 that is below the lower dashed horizontal line in FIG. 12, are then added to the spread data blocks 419/421 and 423/425 to form augmented pairs of data blocks 427/429 and 431/433, respectively. The augmenting processes are indicated in FIG. 12 by hollow arrows 435 and 437, respectively. The prefixes and suffixes are not differentiated from the rest (the data portions) of the augmented pairs of data blocks 427/429 and 431/433 in FIG. 12.

The prefixes and suffixes of the second augmented pair of data blocks 431/433 (those destined for the diversity antenna) are related to the first augmented pair of data blocks 427/429 (those destined for the main antenna) as follows. The prefix of data block 431 is the negative complex conjugate of the suffix of data block 429 in reverse time sequence. The suffix of the data block 431 is negative complex conjugate of the prefix of the data block 429 in reverse time sequence. Optionally, the last symbol of the suffix of data block 431 is then moved to the head of the prefix of that data block to introduce a one symbol offset in time between data block 431 and 427 is desired.

The prefix of the data block 433 is the complex conjugate of the suffix of the first augmented data block 427 in reverse time sequence. The suffix of data block 433 is the complex conjugate of the prefix of data block 427 in reverse time sequence. Optionally, the last symbol of the suffix of data block 433 is then moved to the head of the prefix of that data block to introduce a one symbol offset in time between data block 433 and 429 is desired.

An example of the result of the STUD encoding and the manner in which the prefixes and suffixes have been added to the spread data blocks 419/421 and 423/425 is, in terms of example input data blocks 412/414, as follows:

If the input data blocks 412/414 are:

D₁ [0 → 2464]

followed by:

D₂ [0 → 2464]

where Ds are data, then the first pair of augmented data blocks 427/429 are:

| | | |
|---|---|---|
| P₁ [0 → 47] | D₁ [0 → 2464] | S₁ [0 → 47] |

followed by:

| | | |
|---|---|---|
| P₂ [0 → 47] | D₂ [0 → 2464] | S₂ [0 → 47] |

where Ps are prefixes and Ss are suffixes, and the second pair of augmented data blocks 431/433 are:

| | | |
|---|---|---|
| −S₂ [47 → 0]* | −D₂ [2464 → 0]* | −P₂ [47 → 0]* |

followed by:

| | | |
|---|---|---|
| S₁ [47 → 0]* | D₁ [2464 → 0]* | P₁ [47 → 0]* |

where the sizes of the various portions of each block shown as cells in the above tables are not to scale. In the present model implementation of the invention, S_{1[}0→47]=0 and S₂ [0→47]=0 and the second pair of augmented data blocks 431/433 are:

| | | |
|---|---|---|
| −P₂ [0]*; −S2 [47 → 0]* | −D₂ [2464 → 0]* | −P₂ [47 → 1]* |

followed by:

| | | |
|---|---|---|
| P₁ [0]*; S₁ [47 → 0]* | D₁ [2464 → 0]* | P₁ [47 → 1]* |

so as to introduce a one symbol offset in time between the blocks transmitted by the main and the diversity antennas. In the above discussion, it should be noted that the size (48 symbols) of the prefixes and suffixes are examples only and are usually a function of L.

As discussed above, the channel response length or channel memory L and the estimated tap coefficients h₀, h₁, . . . , h_{L} are assumed to be known to the receiver for each channel. In the following discussion, the channel response length or channel memory is assumed to be the same for both channels. If, for some reason, more estimated tap coefficients are available for one channel than the other, L can still be made the same by padding the estimated tap coefficients with zeros. The estimated tap coefficients for the first channel (referred to as “channel A” and linking the main antenna to the receiver 426) may be represented by h₀^{A}, h₁^{A}, . . . , h_{L}^{A}, and those for the second channel (referred to as “channel B” and linking the diversity antenna to the receiver 426) may be represented by h₀^{B}, h₁^{B}, . . . , h_{L}^{B}. The channels A and B are shown between the two dashed lines in FIG. 12 and are indicated generally by reference numeral 440. Channel A is indicated by a pair of hollow arrows 442 and channel B is indicated by a pair of hollow arrows 444.

The data portion of each of the four STTD encoded blocks 418/420/422/424 may be represented as the N-length sequences of symbols (xⱼ[0], . . . , xⱼ[N−1]), where the index j=1, . . . , 4 identifies the respective STTD encoded blocks. Each STTD encoded block j also includes a prefix (xⱼ[−L], . . . , xⱼ[−1]) and a suffix (xⱼ[N], . . . , xⱼ[N+L−1]).

Preferably, the first pair of STTD encoded blocks 418/420 are scrambled by a scrambling process indicated by a hollow arrow 428, resulting in a first pair of scrambled blocks 430/432 and the second pair of STTD encoded blocks 422/424 are scrambled by a scrambling process indicated by a hollow arrow 434, resulting in a second pair of scrambled blocks 436/438. For each possible value of i, transmitted symbol xⱼ[i] is multiplied by a scrambling sequence element sₘ[i] to obtain a scrambled sequence zⱼ[i]=sₘ[i]xⱼ[i]. In practice, the sequences of scrambling sequence elements sₘ[i] may be different portions of the same very long scrambling sequence. After scrambling, each scrambled block zⱼ[i]=sₘ[i]xⱼ[i] has a scrambled prefix that may be represented by a sequence of symbols (zⱼ[−L], . . . , zⱼ[−1]), a scrambled payload that may be represented by a sequence of symbols (zⱼ[0], . . . , zⱼ[N−1]), and a scrambled suffix that may be represented by a sequence of symbols (zⱼ[N], . . . , zⱼ[N+L−1]).

The scrambled blocks 430/432 for which j=1,2 are transmitted by the transmitter 410 from the main antenna. The scrambled blocks 436/438 for which j=3,4 are transmitted at at most a slight delay by the transmitter 410 from the diversity antenna. Hence the sequences of symbols of zⱼ[n] and z₃[n] (after undergoing processing by the channels A and B, respectively) arrive at the receiver 426 essentially at the same time (ignoring multi-path delays and any delay intentionally added to the signal transmitted from the diversity antenna). Similarly, the sequences of symbols of z₂[n] and z₄[n] (after undergoing processing by the channels A and B, respectively) arrive at the receiver 426 at essentially the same time (again ignoring multi-path delays and any delay intentionally added to the signal transmitted from one of the antennas).

The receiver 426 receives in succession two channel-processed blocks, indicated in FIG. 12 by reference numerals 446 and 448. The first received block 446 is the sum of the first block 430 of first pair of scrambled blocks 430/432 processed by channel A and the first block 436 of second pair of scrambled blocks 436/438 processed by channel B. The second received block 448 is the sum, after processing by the channels 442/444, of the second block 432 of first pair of scrambled blocks 430/432 processed by channel A and the second block 438 of second pair of scrambled blocks 436/438 processed by channel B.

In FIG. 12, the receiver 426 is shown as two processes which exchange data, one for processing the first received block 446 and the other for processing the second received block 448. Those skilled in the art will understand that these processes could be executed in parallel or in series in the receiver 426 and that the hardware needed to execute the two processes may be two separate sets of components or one set of components, which is time-shared by the two processes.

Each of the two received blocks 446/448 which may be represented by yₖ[i], where k=1, 2, has a received prefix, which corresponds to the scrambled prefix and which may be represented by a sequence of symbols (yₖ[−L], . . . , yₖ[−1]), a received payload, which corresponds to the scrambled payload and may be represented by a sequence of symbols (yₖ[0], . . . , yₖ[N−1]) and a received suffix, which corresponds to the scrambled suffix and may be represented by a sequence of symbols (yₖ[N], . . . , yₖ[N+L−1]).

For the first received block 446, a first prefix synthesizing process that is represented in FIG. 12 by a block indicated by reference numeral 450 determines a first synthesized prefix 452, which replaces the prefix of the first received block 446 forming a first synthesized received block 454. For the second received block 448, a prefix synthesizing process that is represented in FIG. 12 by a block indicated by reference numeral 456 determines a second synthesized prefix 458, which replaces the prefix of the second received block 448 forming a second synthesized received block 460. Each prefix synthesizing process 450/456 has been provided with or is able to determine the estimated tap coefficients of the respective channels 442/444 as well as the scrambled prefix and the suffix of the respective pairs of scrambled blocks. The estimated tap coefficients may be obtained by conventional means. The receiver 426 must also know or be able to determine how the prefixes and suffixes of the first pair of STTD encoded blocks 418/420 and the second pair of STTD encoded blocks 422/424 were STTD encoded, what the prefixes and suffixes of the input blocks 412/414 were, and how the encoded prefixes and suffixes were scrambled. In a typical embodiment of the invention, the STTD encoding algorithm, the prefixes and suffixes of the input blocks 412/414, and the scrambling algorithm may be predetermined so that the necessary algorithms to decode and unscramble as well as the prefixes and suffixes may be stored in the receiver 426 or communicated to the receiver 426 upon startup or later.

The synthesized prefixes 452/458 are determined so that the synthesized received blocks 454/460 are estimates of what the actual received blocks 446/448 would have been had each scrambled blocks 430/432/436/438 been preceded by a cyclic prefix when it was transmitted. It will be noted that the cyclic prefixes referred to here would have preceded the scrambled prefixes of the scrambled blocks 430/432/436/438, not been substituted for them.

The synthesized prefixes 452/458, which may be represented by ŷₖ[−L], . . . , ŷₖ[−1], for k=1, 2, are given by:

$$\begin{matrix}{\hat{y}}_{1} [ - L ] = {h}_{0}^{A} {z}_{1} [ - L ] + {h}_{1}^{A} {z}_{1} [ N + L - 1 ] + {h}_{2}^{A} {z}_{1} [ N + L - 2 ] + … + \\ {h}_{L}^{A} {z}_{1} [ N ] + {h}_{0}^{B} {z}_{3} [ - L ] + {h}_{1}^{B} {z}_{3} [ N + L - 1 ] + \\ {h}_{2}^{B} {z}_{3} [ N + L - 2 ] + … + {h}_{L}^{B} {z}_{3} [ N ] \\ {\hat{y}}_{1} [ - L + 1 ] = {h}_{0}^{A} {z}_{1} [ - L + 1 ] + {h}_{1}^{A} {z}_{1} [ - L ] + {h}_{2}^{A} {z}_{1} [ N + L - 1 ] + … + \\ {h}_{L}^{A} {z}_{1} [ N + 1 ] + {h}_{0}^{B} {z}_{3} [ - L + 1 ] + {h}_{1}^{B} {z}_{3} [ - L ] + \\ {h}_{2}^{B} {z}_{3} [ N + L - 1 ] + … + {h}_{L}^{B} {z}_{3} [ N + 1 ] \\ ⋮ ⋮ \\ {\hat{y}}_{1} [ - 1 ] = {h}_{0}^{A} {z}_{1} [ - 1 ] + {h}_{1}^{A} {z}_{1} [ - 2 ] + {h}_{2}^{A} {z}_{1} [ - 3 ] + … + \\ {h}_{L}^{A} {z}_{1} [ N + L - 1 ] + {h}_{0}^{B} {z}_{3} [ - L ] + {h}_{1}^{B} {z}_{3} [ - 2 ] + \\ {h}_{2}^{B} {z}_{3} [ - 3 ] + … + {h}_{L}^{B} {z}_{3} [ N + L - 1 ]\end{matrix}$$

$$and$$

$$\begin{matrix}{\hat{y}}_{2} [ - L ] = {h}_{0}^{A} {z}_{2} [ - L ] + {h}_{1}^{A} {z}_{2} [ N + L - 1 ] + {h}_{2}^{A} {z}_{2} [ N + L - 2 ] + … + \\ {h}_{L}^{A} {z}_{2} [ N ] + {h}_{0}^{B} {z}_{4} [ - L ] + {h}_{1}^{B} {z}_{4} [ N + L - 1 ] + \\ {h}_{2}^{B} {z}_{4} [ N + L - 2 ] + … + {h}_{L}^{B} {z}_{4} [ N ] \\ {\hat{y}}_{2} [ - L + 1 ] = {h}_{0}^{A} {z}_{2} [ - L + 1 ] + {h}_{1}^{A} {z}_{2} [ - L ] + {h}_{2}^{A} {z}_{2} [ N + L - 1 ] + … + \\ {h}_{L}^{A} {z}_{2} [ N + 1 ] + {h}_{0}^{B} {z}_{4} [ - L + 1 ] + {h}_{1}^{B} {z}_{4} [ - L ] + \\ {h}_{2}^{B} {z}_{4} [ N + L - 1 ] + … + {h}_{L}^{B} {z}_{4} [ N + 1 ] \\ ⋮ ⋮ \\ {\hat{y}}_{2} [ - 1 ] = {h}_{0}^{A} {z}_{2} [ - 1 ] + {h}_{1}^{A} {z}_{2} [ - 2 ] + {h}_{2}^{A} {z}_{2} [ - 3 ] + … + \\ {h}_{L}^{A} {z}_{2} [ N + L - 1 ] + {h}_{0}^{B} {z}_{4} [ - L ] + {h}_{1}^{B} {z}_{4} [ - 2 ] + \\ {h}_{2}^{B} {z}_{4} [ - 3 ] + … + {h}_{L}^{B} {z}_{4} [ N + L - 1 ] \end{matrix}$$

A first Discrete Fourier Transform (“DFT”) block 462 of the first synthesized received block 454 is then formed. That DFT process is indicated in FIG. 12 by a hollow arrow 464. Similarly, a second DFT block 466 of the second synthesized received block 460 is also formed. That DFT process is indicated in FIG. 12 by a hollow arrow 468.

The DFT blocks 462/466 are then STTD decoded and equalized in the frequency domain. The first decoded and equalized block 470, which corresponds to the first input block 412, is formed from both DFT blocks 462/466 and the estimated tap coefficients for both channels 442/444. The second decoded and equalized block 472, which corresponds to the second input block 414, is formed from both DFT blocks 462/466 and the estimated tap coefficients for both channels 442/444. The process of forming and equalizing the DFT blocks 462/466 is indicated in FIG. 12 by hollow arrows from each of the DFT blocks 462/466 to each of the decoded and equalized blocks 470/472.

More specifically, if the synthesized received blocks 454/460 are represented respectively by (ŷₖ[−L], . . . , yₖ[−1], yₖ[0], . . . , yₖ[N−1], yₖ[N], . . . , yₖ[N+L−1]), where k=1,2 and the corresponding DFT blocks 462/466 are represented respectively by (Yₖ[−L], . . . , Yₖ[−1], Yₖ[0], . . . , Yₖ[N−1], Yₖ[N], . . . , Yₖ[N+L−1]), then the decoded and equalized blocks 470/472, which may be represented by (Y′ₖ[−L], . . . , Y′ₖ[−1], Yₖ[0], . . . , Y′ₖ[N−1], Y′ₖ[N], . . . , Y′ₖ[N+L−1]), where k=1,2 and determined as follows:

$${Y}_{1}^{′} [ i ] = \frac{{Y}_{1} [ i ] \times {( {H}_{i}^{A} )}^{*} + {( {Y}_{2} [ i ] )}^{*} \times {H}_{i}^{B}}{{\vert {H}_{i}^{A} \vert}^{2} + {\vert {H}_{i}^{B} \vert}^{2}}$$

$${Y}_{2}^{′} [ i ] = \frac{{Y}_{2} [ i ] \times {( {H}_{i}^{A} )}^{*} - {( {Y}_{1} [ i ] )}^{*} \times {H}_{i}^{B} )}{{\vert {H}_{i}^{A} \vert}^{2} + {\vert {H}_{i}^{B} \vert}^{2}} ,$$

where Hᵢ^{A} and Hᵢ^{B} are respectively the i th components of the DFTs of the {hᵢ^{A}} and {hᵢ^{B}}, respectively, and hᵢ^{A} and hᵢ^{B} are the estimated tap coefficients for channels A and B, padded with zeros to have the same length as Y₁[i] and Y₂[i], namely N+2L.

Each of the decoded and equalized blocks 470/472, which may be represented by Y₁[i] and Y₂[i], is then subjected to an Inverse Discrete Fourier Transforms (“IDFT”) to take them into the time domain and the results unscrambled and despread to produce estimates 474/476 of the respective input blocks 412/414. The IDFT, unscrambling, and despreading processes performed on the decoded blocks 470/472 are collectively indicated in FIG. 12 by hollow arrows 478 and 480, respectively.

The method for forming synthesized received blocks in systems that include STTD encoding described above parallels the method described in relation to FIG. 4. The methods described in relation to FIGS. 5, 6, 8, and 9 may also be applied forming synthesized received blocks to systems that include STTD encoding in a straightforward manner that will be clear to those skilled in the art.

In the above description of the invention and in the claims, where the context requires, L need not be numerically equal to the channel response length. As those skilled in the art will understand, L may be equal to or greater than the channel response length. If L is less than the channel response length, then equalization will be less accurate than would be the case if it were equal to the channel response length. It should be understood that, in general, a more accurate equalization can be obtained by estimating or otherwise determining more tap coefficients rather than fewer. Ideally, L should be at least equal to the number of tap coefficients so determined. Further, no advantage is obtained from having prefix and/or suffix lengths greater than the number of determined tap coefficients. Similarly, while having the length of the prefix not equal to the length of the suffix is permissible, the data payload transmitted in a data block will be reduced, without an improvement in equalization.

Those skilled in the art will understand that there are methods for determining the prefix and the suffix from the data block after the data block has been received. Hence, in the above description of the invention and in the claims, if the suffix and the prefix are described as “known”, then it is sufficient that they be “knowable”. In other words, “known” includes “knowable”.

In the above description of the invention and in the claims, “payload” shall mean all symbols between a prefix and the next suffix, between suffixes, if there are only suffixes, or between prefixes, if there are only prefixes. This means that all symbols so defined as payload are equalized; even if the receiver knows some of them. In the case in which there are prefixes, any symbols between a suffix and the next prefix is not equalized.

It also should be noted that wherever data is referred to as having been received, recovered, obtained, or otherwise determined, what is intended is that an estimate of the transmitted data is obtained from the received data using well-known signal processing techniques, as will be apparent to those of skill in the art.

As those skilled in the art will understand, there are many variations of the inventive method and system that are possible. Therefore, the scope of the invention is defined and limited only by the appended claims.

1. A method of equalizing a received scrambled block that was transmitted through a channel, the scrambled block having a prefix, a payload, and a suffix, the method comprising the steps of:
determining a synthesized portion of a synthesized block that would have been received if the suffix of the scrambled block had been identical to the prefix when the scrambled block was transmitted, the synthetic block having a prefix, a payload, and a suffix corresponding to the prefix, the payload, and the suffix of the received scrambled block, and the synthesized portion selected from the group consisting of the prefix, the payload, and the suffix of the synthetic block;
forming the synthesized block from the synthesized portion and a portion of the received scrambled block by appending the payload and suffix of the received scrambled block to the synthesized portion to form the synthesized block if the selected synthesized portion is the prefix of the synthesized block, the suffix of the received scrambled block to the synthesized portion to form the synthesized block if the selected synthesized portion is the payload of the synthesized block, and the synthesized portion to the payload of the received scrambled block to form the synthesized block if the selected synthesized portion is the suffix of the synthesized block;
determining a discrete Fourier transform of the synthesized block to obtain a determined discrete Fourier transform;
performing a frequency domain equalization on the determined discrete Fourier transform; and
determining an inverse discrete Fourier transform of the result of the frequency domain equalization to obtain an estimate of the scrambled payload that was transmitted.

2. The method of claim 1, wherein the prefix and the suffix of the transmitted scrambled block are known.

3. The method of claim 2, wherein the channel has a known channel response length and the prefix and suffix of the transmitted scrambled block have lengths at least equal to the channel response length.

4. The method of claim 3, wherein the prefix and suffix of the transmitted scrambled block each have the same length, which is equal to the channel response length.

5. A method of equalizing a received scrambled block that was transmitted through a channel, the scrambled block having a prefix, a payload, and a suffix, the method comprising the steps of:
determining a synthesized prefix of a synthesized block that would have been received if the suffix of the scrambled block had been identical to the prefix when the scrambled block was transmitted;
forming the synthesized block from the synthesized prefix and the received scrambled block by replacing the prefix of the received scrambled block with the synthesized prefix;
determining a discrete Fourier transform of the synthesized block to obtain a determined discrete Fourier transform;
performing a frequency domain equalization on the determined discrete Fourier transform; and
determining an inverse discrete Fourier transform of the result of the frequency domain equalization to obtain an estimate of the scrambled payload that was transmitted.

6. The method of claim 5, wherein the prefix and the suffix of the transmitted scrambled block are known.

7. The method of claim 6, wherein the channel has a known channel response length and the prefix and suffix of the transmitted scrambled block have lengths at least equal to the channel response length.

8. The method of claim 7, wherein the prefix and suffix of the transmitted scrambled block each have the same length, which is equal to the channel response length.

9. The method of claim 8, wherein the scrambled block is represented by a sequence of data symbols and the prefix of the synthetic block is determined by sending a sequence of data symbols that represents the suffix of the transmitted scrambled block followed by a sequence of data symbols that represents the prefix of the transmitted scrambled block through a model of the channel and retaining the portion of the resulting sequence corresponding to the sequence of data symbols that represents the prefix as the prefix of the synthetic block.

10. The method of claim 9, wherein the channel is modeled by an FIR filter.

11. A method of equalizing a received scrambled block that was transmitted through a channel, the scrambled block having a prefix, a payload, and a suffix, the method comprising the steps of:
determining a synthesized payload of a synthesized block that would have been received if the suffix of the scrambled block had been identical to the prefix when the scrambled block was transmitted;
forming the synthesized block from the synthesized payload and the received scrambled block by replacing the payload of the received scrambled block with the synthesized payload and removing the prefix of the received scrambled block;
determining a discrete Fourier transform of the synthesized block to obtain a determined discrete Fourier transform;
performing a frequency domain equalization on the determined discrete Fourier transform; and
determining an inverse discrete Fourier transform of the result of the frequency domain equalization to obtain an estimate of the scrambled payload that was transmitted.

12. The method of claim 11, wherein the prefix and the suffix of the transmitted scrambled block are known.

13. The method of claim 12, wherein the channel has a known channel response length and the prefix and suffix of the transmitted scrambled block have lengths at least equal to the channel response length.

14. The method of claim 13, wherein the prefix and suffix of the transmitted scrambled block each have the same length, which is equal to the channel response length.

15. The method of claim 14, wherein the scrambled block is represented by a sequence of data symbols and the payload of the synthetic block is determined by:
forming, data symbol by data symbol, a difference sequence, each data symbol of which is a discrete data symbol of the sequence that represents the prefix of the transmitted scrambled block subtracted from the corresponding data symbol of the sequence that represents the suffix of the transmitted scrambled block;
sending the difference sequence through a model of the channel to determine an output sequence; and
forming the payload of the synthetic block by adding, data symbol by data symbol, the output sequence to the sequence that represents the payload of the received scrambled block beginning with the first data symbol of each.

16. The method of claim 15, wherein the channel is modeled by an FIR filter.

17. A method of equalizing a received scrambled block that was transmitted through a channel, the scrambled block having a prefix, a payload, and a suffix, the method comprising the steps of:
determining a synthesized suffix of a synthetic block that would have been received if the suffix of the scrambled block had been identical to the prefix when the scrambled block was transmitted;
forming the synthesized block from the synthesized suffix and the received scrambled block by replacing the suffix of the received scrambled block with the synthesized suffix and removing the prefix of the received scrambled block;
determining a discrete Fourier transform of the synthesized block to obtain a determined discrete Fourier transform;
performing a frequency domain equalization on the determined discrete Fourier transform; and
determining an inverse discrete Fourier transform of the result of the frequency domain equalization to obtain an estimate of the scrambled payload that was transmitted.

18. The method of claim 17, wherein the prefix and the suffix of the transmitted scrambled block are known.

19. The method of claim 18, wherein the channel has a known channel response length and the prefix and suffix of the transmitted scrambled block have lengths at least equal to the channel response length.

20. The method of claim 19, wherein the prefix and suffix of the transmitted scrambled block each have the same length, which is equal to the channel response length.

21. The method of claim 20, wherein the scrambled block is represented by a sequence of data symbols and the suffix of the synthetic block is determined by: forming, data symbol by data symbol, a difference sequence, each data symbol of which is a discrete data symbol of the sequence that represents the suffix of the transmitted scrambled block subtracted from the corresponding data symbol of the sequence that represents the prefix of the transmitted scrambled block;
sending the difference sequence through a model of the channel to determine an output sequence; and
forming the suffix of the synthetic block by adding, data symbol by data symbol, the output sequence to the sequence that represents the suffix of the received scrambled block beginning with the first data symbol of each.

22. The method of claim 21, wherein the channel is modeled by an FIR filter.

23. A method of transmitting a payload through a channel to a receiver, comprising the steps of:
forming a block in which the payload is preceded in the block by a prefix and followed in the block by a suffix;
scrambling the block prior to transmission;
transmitting the scrambled block through the channel to the receiver to obtain a received scrambled block; and, at the receiver,
equalizing the received scrambled block by determining a portion of a synthetic block that would have been received if the suffix of the scrambled block had been identical to the prefix when the scrambled block was transmitted, the synthetic block having a prefix, a payload, and a suffix corresponding the prefix, the payload, and the suffix of the received scrambled block, and the synthesized portion selected from the group consisting of the prefix, the payload, and the suffix of the synthetic block, forming an intermediate block from the synthesized portion and a portion of the received scrambled block by appending the payload and suffix of the received scrambled block to the synthesized portion to form the intermediate block if the synthesized portion is the prefix, the suffix of the received scrambled block to the synthesized portion to form the intermediate block if the synthesized portion is the payload, and the synthesized portion to the payload of the received scrambled block to form the intermediate block if the synthesized portion is the suffix, determining a discrete Fourier transform of the intermediate block to obtain a determined discrete Fourier transform, performing a frequency domain equalization on the determined discrete Fourier transform, and determining an inverse discrete Fourier transform of the result of the frequency domain equalization to obtain an estimate of the scrambled payload that was transmitted; and
unscrambling the estimate of the scrambled payload to recover the transmitted data payload.

24. A method of transmitting a payload through a channel to a receiver, comprising the steps of:
forming a block in which the payload is preceded in the block by a prefix and followed in the block by a suffix;
scrambling the block prior to transmission;
transmitting the scrambled block through the channel to the receiver to obtain a received scrambled block; and at the receiver,
equalizing the received scrambled block by determining a prefix of a synthetic block that would have been received if the suffix of the scrambled block had been identical to the prefix when the scrambled block was transmitted, forming an intermediate block from the synthesized prefix and the received scrambled block by replacing the prefix of the received scrambled block with the synthesized prefix, determining a discrete Fourier transform of the intermediate block to obtain a determined discrete Fourier transform, performing a frequency domain equalization on the determined discrete Fourier transform, and determining an inverse discrete Fourier transform of the result of the frequency domain equalization to obtain an estimate of the scrambled payload that was transmitted; and
unscrambling the estimate of the scrambled payload to recover the transmitted data payload.

25. A method of transmitting a payload through a channel to a receiver, comprising the steps of:
forming a block in which the payload is preceded in the block by a prefix and followed in the block by a suffix;
scrambling the block prior to transmission;
transmitting the scrambled block through the channel to the receiver to obtain a received scrambled block; and at the receiver,
equalizing the received scrambled block by determining a payload of a synthetic block that would have been received if the suffix of the scrambled block had been identical to the prefix when the scrambled block was transmitted, forming an intermediate block from the synthesized payload and the received scrambled block by replacing the payload of the received scrambled block with the synthesized payload and removing the prefix of the received scrambled block, determining a discrete Fourier transform of the intermediate block to obtain a determined discrete Fourier transform, performing a frequency domain equalization on the determined discrete Fourier transform, and determining an inverse discrete Fourier transform of the result of the frequency domain equalization to obtain an estimate of the scrambled payload that was transmitted; and
unscrambling the estimate of the scrambled payload to recover the transmitted data payload.

26. A method of transmitting a payload through a channel to a receiver, comprising the steps of:
forming a block in which the payload is preceded in the block by a prefix and followed in the block by a suffix;
scrambling the block prior to transmission;
transmitting the scrambled block through the channel to the receiver to obtain a received scrambled block; and at the receiver;
equalizing the received scrambled block by determining a suffix of a synthetic block that would have been received if the suffix of the scrambled block had been identical to the prefix when the scrambled block was transmitted, forming an intermediate block from the synthesized suffix and the received scrambled block by replacing the suffix of the received scrambled block with the synthesized suffix and removing the prefix of the received scrambled block, determining a discrete Fourier transform of the intermediate block to obtain a determined discrete Fourier transform, performing a frequency domain equalization on the determined discrete Fourier transform, and determining an inverse discrete Fourier transform of the result of the frequency domain equalization to obtain an estimate of the scrambled payload that was transmitted; and
unscrambling the estimate of the scrambled payload to recover the transmitted data payload.

27. The method of claim 23, wherein the prefix and the suffix of the transmitted scrambled block are known.

28. The method of claim 27, wherein the channel has a known channel response length and the prefix and suffix of the transmitted scrambled block have lengths at least equal to the channel response length.

29. The method of claim 28, wherein the prefix and suffix of the transmitted scrambled block each have the same length, which is equal to the channel response length.

30-43. (canceled)

44. The method of claim 24, wherein the prefix and the suffix of the transmitted scrambled block are known.

45. The method of claim 44, wherein the channel has a known channel response length and the prefix and suffix of the transmitted scrambled block have lengths at least equal to the channel response length.

46. The method of claim 45, wherein the prefix and suffix of the transmitted scrambled block each have the same length, which is equal to the channel response length.

47. The method of claim 25, wherein the prefix and the suffix of the transmitted scrambled block are known.

48. The method of claim 47, wherein the channel has a known channel response length and the prefix and suffix of the transmitted scrambled block have lengths at least equal to the channel response length.

49. The method of claim 48, wherein the prefix and suffix of the transmitted scrambled block each have the same length, which is equal to the channel response length.

50. The method of claim 26, wherein the prefix and the suffix of the transmitted scrambled block are known.

51. The method of claim 50, wherein the channel has a known channel response length and the prefix and suffix of the transmitted scrambled block have lengths at least equal to the channel response length.

52. The method of claim 51, wherein the prefix and suffix of the transmitted scrambled block each have the same length, which is equal to the channel response length.
